(19) United States
(12) Patent Application Publication
(10) Pub. No.: US 2018/0131315 A1
(43) Pub. Date: May 10, 2018

(54) Solar Stand

(71) Applicant: Milton Roy, LLC, Ivyland, PA (US)

(72) Inventors: Christopher K. Tromley, Penn Valley, PA (US); Stanley E. Stutzman, Linden, PA (US)

(73) Assignee: Milton Roy, LLC, Ivyland, PA (US)

(21) Appl. No.: 15/344,275

(22) Filed: Nov. 4, 2016

(51) Int. Cl. H02S 20/30; F16M 11/24; H02S 40/38

(52) U.S. Cl. CPC H02S 20/30; F16M 11/245; F16M 2200/024; F16M 2200/028; H02S 40/38

(57) ABSTRACT

A stand for mounting a solar panel and an electronics enclosure includes a pole having a spreader attached to a bottom end of the pole, where the pole includes a first hole and second hole sized to accept a hitch pin. The first hole corresponds to a collapsed state of the stand and the second hole corresponds to an deployed state of the stand. A hub is slidably mounted to the pole and includes a first hole corresponding to the first hole in the pole and the collapsed state of the stand and a notch corresponding to the second hole in the stand and the deployed state of the stand. A plurality of legs are pivotably attached to the hub, where the legs spread outward from the hub by the spreader when the stand is in the deployed state. In the deployed state, the hitch pin is inserted through the second hole in the pole and rests in the notch in the hub, where the notch preventing the pole from rotating relative to the hub.

### TECHNICAL FIELD

The present disclosure is directed to a stand for a solar panel, and more particularly to a collapsible stand for holding a solar panel and an electronics enclosure associated with a chemical pump in a non-rotatable orientation.

### BACKGROUND OF THE INVENTION

When chemicals must be injected in remote locations, such as gas and oil wellheads or mines, a DC powered pump is commonly used. Typically a structure is provided to support one or more solar panels and an enclosure containing one or more batteries and control electronics for charging the batteries and operating a pump. A DC powered pump may be mounted on the structure as well, or on its own separate pedestal.

Typically, stands to support a solar panel for such an application are made with a base and a vertical pole. The base and pole are delivered apart and are joined onsite by inserting the pole into the base. A solar panel can then be mounted on the upper end of the pole. For ease of transport and to minimize cost the base is small (2′-3′ square). The small base can result in instability where the solar panel is subject to windy environments. Further, joining pole to base usually requires fasteners, meaning tools are needed as well as spare fasteners to replace the inevitable lost hardware.

### BRIEF SUMMARY OF THE INVENTION

In a preferred embodiment a stand for mounting a solar panel and an electronics enclosure is described. The stand includes a pole having a spreader attached to a bottom end of the pole, where the pole includes a first hole and second hole sized to accept a hitch pin, the first hole corresponds to a collapsed state of the stand and the second hole corresponds to a deployed state of the stand. A hub is slidably mounted to the pole and includes a first hole corresponding to the first hole in the pole and the collapsed state of the stand and a notch corresponding to the second hole in the pole and the deployed state of the stand. A plurality of legs are pivotably attached to the hub, where the legs spread outward from the hub by the spreader when the stand is in the deployed state. In the deployed state, the hitch pin is inserted through the second hole in the pole and rests in the notch in the hub, where the notch prevents the pole from rotating relative to the hub.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of a stand system for a solar panel according to the concepts described herein;

FIG. 2 is a side view of a solar stand according to the concepts described herein in a collapsed state;

FIG. 3 is a perspective view of the solar stand of FIG. 2 in a deployed state;

FIG. 4 is a perspective view of a remote chemical pump system employing the solar stand system of FIG. 1; and

FIGS. 5 and 6 are perspective views of the solar stand of FIG. 3 with an electronics enclosure attached.

### DETAILED DESCRIPTION OF THE INVENTION

Existing designs for solar panel stands utilize a small base and a pole that inserts into the base and is usually attached using nuts and bolts or other connecting hardware. The small base can make the stand unstable when a solar panel is attached since the solar panel can function as a sail in windy conditions. Further, keeping up with and transporting the separate components and connecting hardware can be tricky in the remote environments in which the solar stand is used.

The present design according to the concepts described herein uses a single piece design and can be transported in a very compact state. It can be erected very easily and quickly without the need for tools or connecting hardware. It has a broader footprint than competitive products, thereby providing much greater stability in high winds.

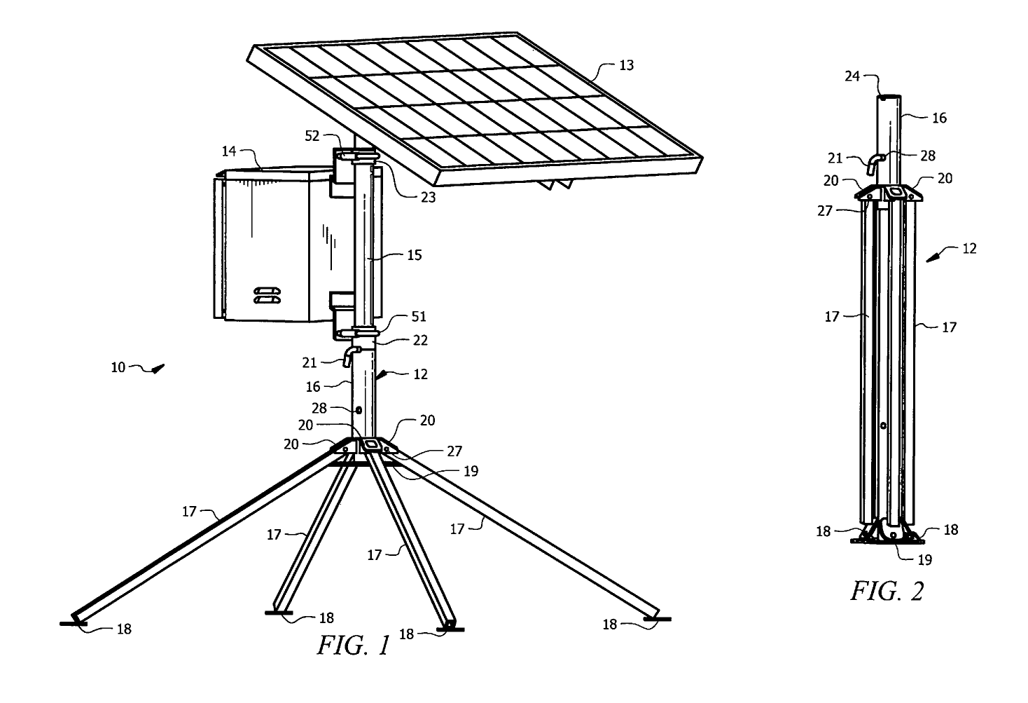

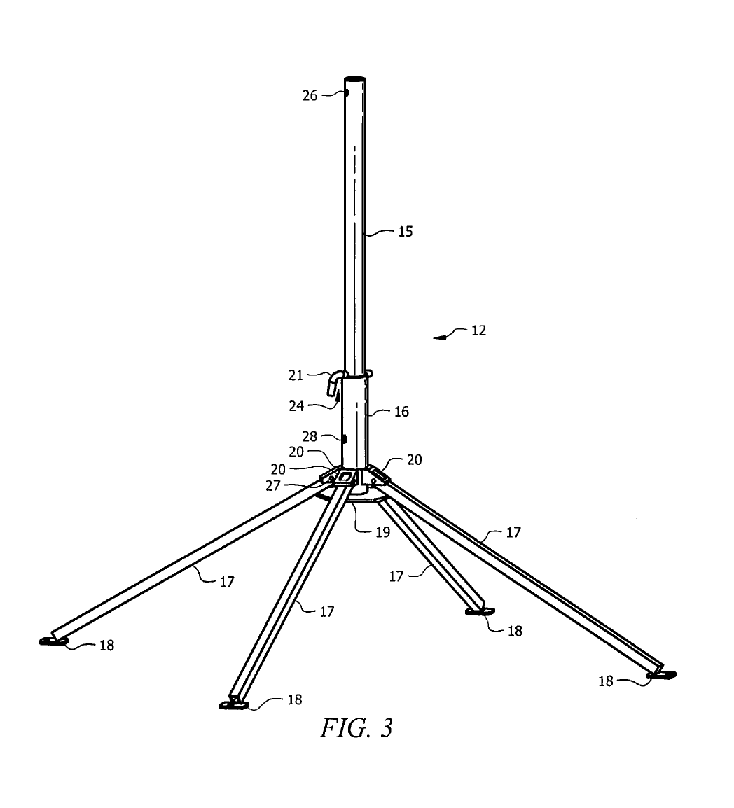

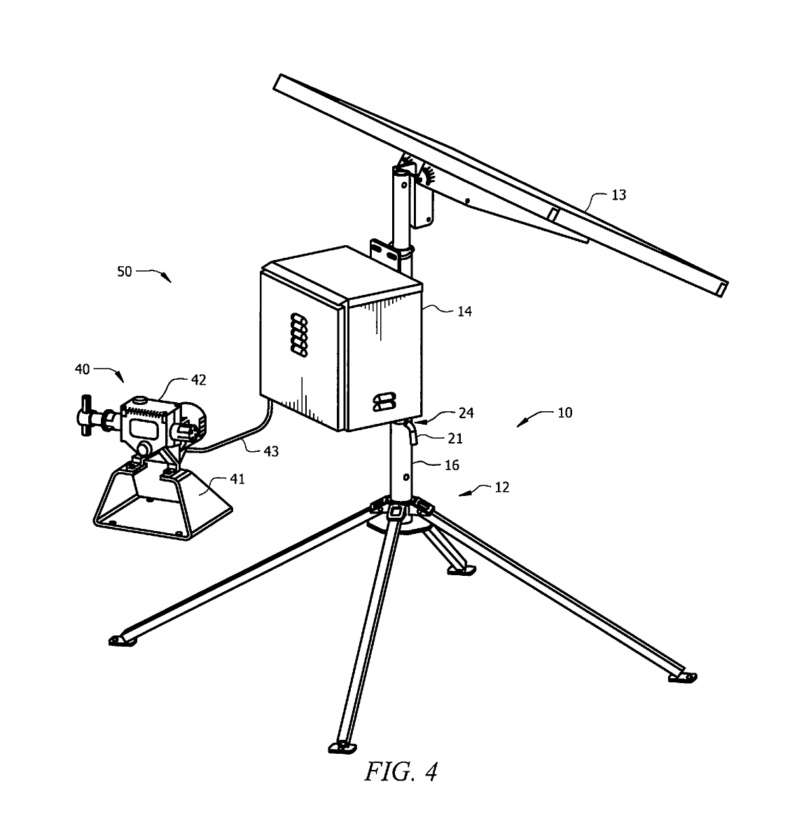

Referring now to FIGS. 1-3, an embodiment of a solar panel stand system (FIG. 1) and an embodiment of a solar stand (FIGS. 2 and 3) according to the concepts described herein are shown. Stand system 10 includes a stand 12 with a solar panel 13 and electronic enclosure 14 attached. A preferred embodiment of stand 12 includes pole 15 to which solar panel 13 and electronics enclosure 14 can be attached. The solar panel is used to produce electricity that can be used to power equipment such as a chemical pump. The electronics enclosure contains power supply circuitry and a battery used to store electricity produced by the solar panel. Equipment, such as the chemical pump, can be plugged into the power supply circuitry and powered by the solar panel and/or battery.

Pole 15 is slidably inserted into hub 16 which has a number of legs 17 attached. In a preferred embodiment, stand 12 has four legs for increased stability but the stand may have three legs or five or more legs without departing from the scope of the concepts described herein. Legs 17 are attached to hub 16 by leg supports 20. Leg supports 20 include pivot points 27 around which the legs can move relative to the hub. Leg supports 20 also set a maximum angle for the legs when fully deployed. Feet 18 at the end of each leg 17 provide for increased stability when the stand is in use. At the end of pole 15 is spreader 19 which forces the legs outward as hub 16 is slide down pole 15 into its deployed position.

Stand 12 is shown in a collapsed position in FIG. 2 and a deployed or erect position in FIG. 3. As described, pole 15 slides through hub 16 that has legs 17 permanently attached to it using leg supports 20 and pivots 27. In its collapsed state, hub 16 is drawn up pole 15 (or pole 15 is inserted into hub 16), this allows legs 17 to pivot downward and rest against pole 15 and hub 16, as can be seen in FIG. 2. Stand 12 can be held in the collapsed state by inserting a hitch pin 21 through a hole 28 in hub 16 and a corresponding hole in pole 15.

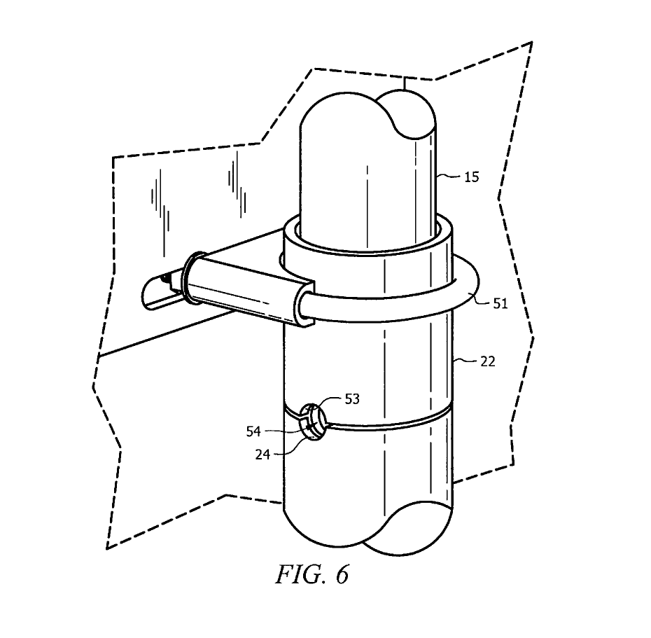

To erect the stand, hub 16 is slid to the bottom of pole 15 and pinned in place by inserting a hitch pin 21 through a u-shaped notch 24 in the hub and into a matching hole in pole 15. A spreader 19, which is welded, or otherwise attached, to pole 15, forces the legs 17 into position and prevents the legs from folding back down. When upright, gravity holds the hitch pin in notch 24 in the top edge of hub 16 to prevent the pole (and the solar panel attached to its top) from rotating relative to the hub. The electronics enclosure 14 has a top ring 23 and bottom ring 22 attached to it with U-bolts 52 and 51, to allow it to slide over pole 15. Another notch 53 (shown in FIGS. 5 and 6) in the bottom edge of the bottom ring 22 prevents the enclosure from rotating around pole 15, as is shown in greater detail with reference to FIGS. 5 and 6.

To collapse for transport or storage, the solar panel 13 and its mount are removed and the electronics enclosure 14 with its attached rings is slid off the top of the pole 15. The hitch pin 21 is removed and the hub 16 with its attached legs 17 is slid up the pole 15. The hitch pin 21 is inserted into hole 28 in the hub and its corresponding hole 26 in pole 15 to hold the stand 12 in its collapsed state. When collapsed, preferred embodiments of stand 12 reduce to a roughly cylindrical volume that is 7″ in diameter by 4′ long. This is a significant benefit, allowing more systems to be loaded for transport to sites without requiring return trips. The stand system described herein can be erected in seconds with no tools. When erect, the legs extend to a footprint of 4′ on a side. The legs 17 are locked in place to retain stability when high winds rock the system.

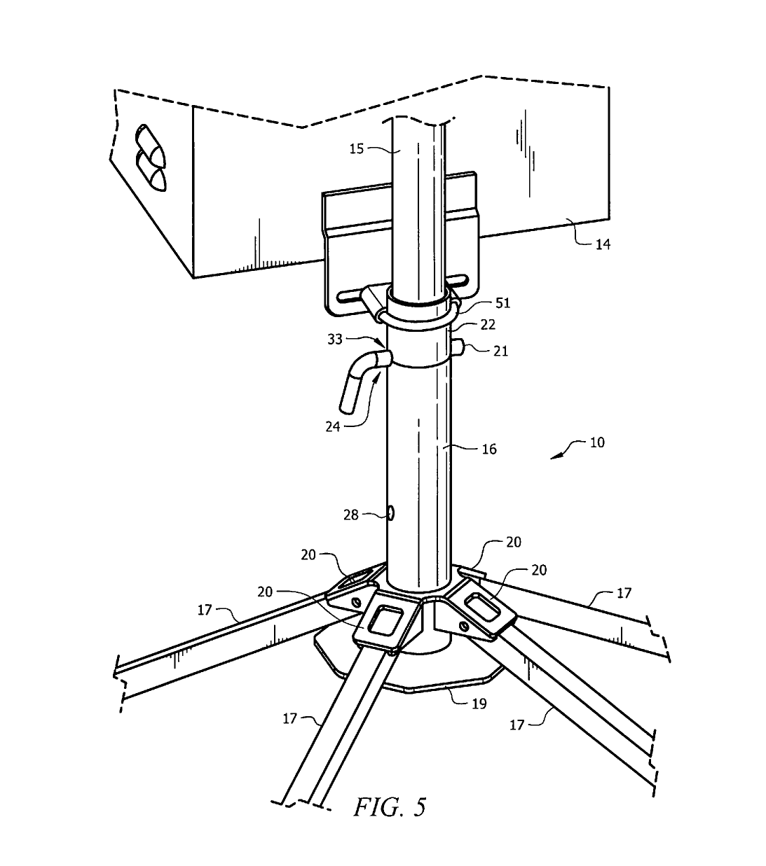

Referring now to FIG. 4, a preferred embodiment of a remote pump system is shown. Pump system 50 includes solar stand assembly 10, as shown in FIG. 1 and pump assembly 40. Solar stand assembly 10 includes stand 12, solar panel 13 and electronics enclosure 14. As stated above, electronics enclosure 14 and solar panel 13 mount on stand 12. Hitch pin 21 inserted through pole 15 secures stand 12 in the erect or deployed position. Notch 24 in hub 16 and a corresponding notch in the bottom ring described with reference to FIGS. 1-3, prevent the electronics enclosure 14 and the solar panel 13 from rotating relative to stand 12.

Pump assembly 40 consists of pump 42 mounted on pump stand 41. Cable 43 connects pump 42 to electronics enclosure 14. Cable 43 and electronics enclosure 14 provide power to pump 42. Additionally, in certain embodiments, control circuitry for pump 42 could be included in electronics enclosure 14 with control signals also passing through cable 43. In other embodiments, the control circuitry for pump 42 is included on pump 42.

Referring now to FIGS. 5 and 6, a detailed view of a preferred embodiment of the relationship between hub 16, bottom ring 22 and pole 15 is shown. FIG. 5 shows the hitch pin 21 installed while FIG. 6 shows the assembly without hitch pin 21 inserted into hole 54. Hitch pin 21 prevents electronics enclosure 14 from rotating by having notch 53 on bottom ring 22 engaged with hitch pin 21. In order to rotate, electronics enclosure would have to lift up to free notch 53 from hitch pin 21. The weight of electronics enclosure 14 prevents the lifting by the force of wind or unintentional contact with electronics enclosure 14. Similarly notch 24 in hub 16 prevents pole 15 and thereby the solar panel from rotating in the same fashion. To rotate, pole 15 holding the solar panel would have to lift to free itself from notch 24 even without electronics enclosure 14 installed. With electronics enclosure installed the weight of the enclosure adds to the force required to rotate the solar panel.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A stand comprising:
a pole having a fixed disk attached to a bottom end of the pole, the pole including a first hole and second hole sized to accept a hitch pin, the first hole corresponding to a collapsed state of the stand and the second hole corresponding to a deployed state of the stand;
a hub slidably mounted to the pole, the hub including a first hole corresponding to the first hole in the pole and the collapsed state of the stand and a notch corresponding to the second hole in the stand and the deployed state of the stand; and
a plurality of legs pivotably attached to the hub, the legs spread outward from the hub by the fixed disk when the stand is in the deployed state;
wherein, in the deployed state, the hitch pin is inserted through the second hole in the pole and rests in the notch in the hub, the notch preventing the pole from rotating relative to the hub.

2. The stand of claim 1 further comprising an electronics enclosure mounted to the stand using a top ring and a bottom ring attached to the electronics enclosure, the top ring and the bottom ring sliding onto the pole.

3. The stand of claim 2 wherein the bottom ring includes a notch that engages with the hitch pin and prevents the electronics enclosure from rotating.

4. The stand of claim 1 wherein the plurality of legs comprises four legs.

5. The stand of claim 1 wherein the plurality of legs attach to the hub using a plurality of leg supports, each of the plurality of leg supports corresponding to one of the plurality of legs, wherein the plurality of leg supports holds the plurality of legs at a desired angle from the hub when the stand is in the deployed state.

6. The stand of claim 1 further comprising a solar panel mounted to the top of the pole.

7. A method for deploying a portable stand, the method comprising:
sliding a hub along a pole, the pole having a fixed disk attached to a bottom end of the pole, the pole including a first hole and second hole sized to accept a hitch pin, the first hole corresponding to a collapsed state of the stand and the second hole corresponding to an deployed state of the stand and the hub including a first hole corresponding to the first hole in the pole and the collapsed state of the stand and a notch corresponding to the second hole in the stand and the deployed state of the stand wherein a plurality of legs pivotably attached to the hub spread outward from the hub by the fixed disk when the stand is in the deployed state; and
inserting the hitch pin through the second hole in the pole such that the hitch pin rests in the notch in the hub, the notch preventing the pole from rotating relative to the hub.

8. The method of claim 7 wherein the stand further comprises an electronics enclosure mounted to the stand using a top ring and a bottom ring attached to the electronics enclosure, the top ring and the bottom ring sliding onto the pole.

9. The method of claim 8 wherein the bottom ring includes a notch that engages with the hitch pin and prevents the electronics enclosure from rotating.

10. The method of claim 7 wherein the plurality of legs comprises four legs.

11. The method and of claim 7 wherein the plurality of legs attach to the hub using a plurality of leg supports, each of the plurality of leg supports corresponding to one of the plurality of legs, wherein the plurality of leg supports holds the plurality of legs at a desired angle from the hub when the stand is in the deployed state.

12. The method of claim 7 wherein the stand further comprises a solar panel mounted to the top of the pole.

13. A power supply for a remote pump comprising:
a stand, the stand comprising: a pole having a fixed disk attached to a bottom end of the pole, the pole including a first hole and second hole sized to accept a hitch pin, the first hole corresponding to a collapsed state of the stand and the second hole corresponding to an deployed state of the stand; a hub slidably mounted to the pole, the hub including a first hole corresponding to the first hole in the pole and the collapsed state of the stand and a notch corresponding to the second hole in the stand and the deployed state of the stand; and a plurality of legs pivotably attached to the hub, the legs spread outward from the hub by the fixed disk when the stand is in the deployed state; wherein, in the deployed state, the hitch pin is inserted through the second hole in the pole and rests in the notch in the hub, the notch preventing the pole from rotating relative to the hub;
a solar panel mounted to the stand;
an electronics enclosure mounted to the stand and electrically connected to the solar panel, the electronics enclosure including a battery and power supply circuitry.

14. The power supply of claim 13 wherein the electronics enclosure mounts to the stand using a top ring and a bottom ring attached to the electronics enclosure, the top ring and the bottom ring sliding onto the pole.

15. The power supply of claim 14 wherein the bottom ring includes a notch that engages with the hitch pin and prevents the electronics enclosure from rotating.

16. The power supply of claim 13 wherein the plurality of legs comprises four legs.

17. The power supply and of claim 13 wherein the plurality of legs attach to the hub using a plurality of leg supports, each of the plurality of leg supports corresponding to one of the plurality of legs, wherein the plurality of leg supports holds the plurality of legs at a desired angle from the hub when the stand is in the deployed state.

18. The power supply of claim 13 wherein the solar panel mounts to the top of the pole.
